(19) United States
(12) Patent Application Publication
(10) Pub. No.: US 2025/0264624 A1
(43) Pub. Date: Aug. 21, 2025

(54) METHOD AND SYSTEM FOR BIN-DEPENDENT DETERMINATION OF FIRST ARRIVALS

(71) Applicant: SAUDI ARABIAN OIL COMPANY, Dhahran (SA)

(72) Inventor: Hassan Jummah I. Al Salim, Qatif (SA)

(73) Assignee: SAUDI ARABIAN OIL COMPANY, Dhahran (SA)

(21) Appl. No.: 18/582,325

(22) Filed: Feb. 20, 2024

(51) Int. Cl. G01V 1/34; E21B 41/00; E21B 49/00; G01V 1/28; G06N 20/00

(52) U.S. Cl. CPC G01V 1/345; E21B 41/00; E21B 49/00; G01V 1/282; G06N 20/00; E21B 2200/20; E21B 2200/22

(57) ABSTRACT

Examples of methods and systems are disclosed. The methods may include receiving a seismic dataset, wherein the seismic dataset comprises a plurality of time-space waveforms, and forming a training waveform set from a subset of the plurality of time-space waveforms. The methods may also include generating a plurality of training subsets from the training waveform set and determining a plurality of initial first arrivals based on the plurality of training subsets. The methods may further include forming a training dataset, wherein the training dataset comprises an input training dataset and an output training dataset, wherein the input training dataset is based on the plurality of training subsets and the output training dataset is based on the plurality of initial first arrivals, and training, using the training dataset, a machine-learning (ML) network to predict the output training dataset, at least in part, from the input training dataset.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic dataset.

To determine the earth structure, including the presence of hydrocarbons, the seismic dataset may be processed. Processing a seismic dataset includes a sequence of steps designed to correct for a number of issues, such as near-surface effects, irregularities in the seismic survey geometry, etc. Seismic data may be also processed to extract seismic characteristics, such as arrival times, to be used with inversion techniques in the generation of high-resolution images of subsurface regions to assist in identification of fine geological features. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method. The method includes receiving, by a seismic processing system including a trainable machine-learning (ML) network, a seismic dataset regarding a subsurface region of interest, wherein the seismic dataset comprises a plurality of time-space waveforms organized in a first data domain. The method also includes using the seismic processing system in forming a training waveform set from a subset of the plurality of time-space waveforms, wherein the training waveform set is organized in a second data domain, and wherein an extent of the second data domain comprises an extent of the first data domain. The method further includes partitioning the first data domain in training bins to generate a plurality of training subsets from the training waveform set, wherein each training subset is associated to a corresponding training bin, and determining a plurality of initial first arrivals based on the plurality of training subsets, wherein each initial first arrival is associated to a corresponding training subset, and wherein each initial first arrival is based on picking a first arrival of at least one time-space waveform of the corresponding training subset. The method still further includes forming a training dataset, wherein the training dataset comprises an input training dataset and an output training dataset, wherein the input training dataset is based on the plurality of training subsets and the output training dataset is based on the plurality of initial first arrivals, and training, using the training dataset, the machine-learning (ML) network to predict the output training dataset, at least in part, from the input training dataset.

In general, in one aspect, embodiments disclosed herein relate to a system. The system includes a seismic processing system including a trainable machine-learning (ML) network and configured to receive a seismic dataset regarding a subsurface region of interest, wherein the seismic dataset comprises a plurality of time-space waveforms organized in a first data domain. The seismic processing system is also configured to form a training waveform set from a subset of the plurality of time-space waveforms, wherein the training waveform set is organized in a second data domain, and wherein an extent of the second data domain comprises an extent of the first data domain. The seismic processing system is further configured to partition the first data domain in training bins to generate a plurality of training subsets from the training waveform set, wherein each training subset is associated to a corresponding training bin, and determine a plurality of initial first arrivals based on the plurality of training subsets, wherein each initial first arrival is associated to a corresponding training subset, and wherein each initial first arrival is based on picking a first arrival of at least one time-space waveform of the corresponding training subset. The seismic processing system is still further configured to form a training dataset, wherein the training dataset comprises an input training dataset and an output training dataset, wherein the input training dataset is based on the plurality of training subsets and the output training dataset is based on the plurality of initial first arrivals, and train, using the training dataset, the trainable machine-learning (ML) network to predict the output training dataset, at least in part, from the input training dataset.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic acquisition system and a subsurface region of interest, according to one or more embodiments of the present disclosure.

FIG. 2 shows examples of seismic data produced by a seismic acquisition system in accordance with one or more embodiments.

FIG. 3 illustrates an example of a seismic dataset, according to one or more embodiments.

FIG. 4 illustrates an example of a method to determine first arrivals, according to one or more embodiments.

FIG. 5 depicts a neural network in accordance with one or more embodiments.

FIG. 6 depicts a depicts a convolutional neural network in accordance with one or more embodiments.

FIG. 7 depicts a drilling system in accordance with one or more embodiments.

FIG. 8 shows a flowchart in accordance with one or more embodiments.

FIG. 9 shows a flowchart in accordance with one or more embodiments.

FIG. 10 shows an example of errors at different progression stages, according to one or more embodiments.

FIG. 11 illustrates an example of a seismic dataset, according to one or more embodiments.

FIG. 12 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

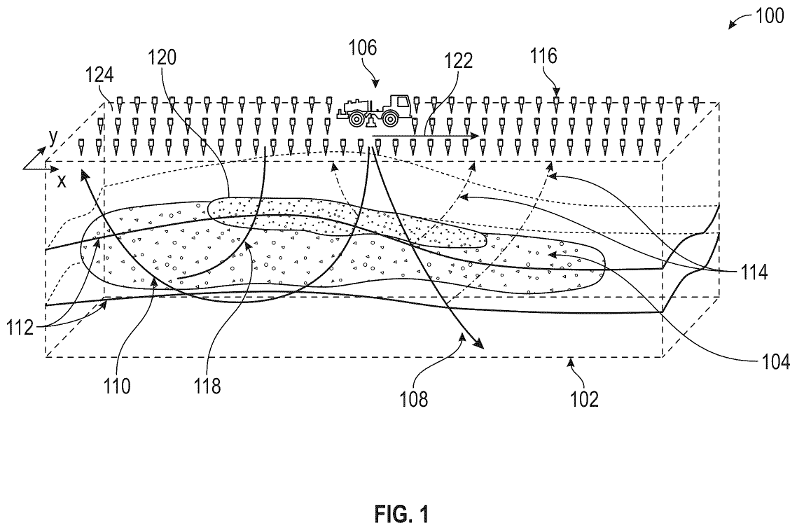

In the following description of FIGS. 1-12, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to determine the travel time of first arrivals of seismic signals. In particular, in some embodiments a seismic dataset may be processed with a machine-learning (ML) network, trained with “initial first arrivals”, i.e., first arrival times that have been determined from a representative portion of the seismic dataset. As such, the initial first arrivals used to train the ML network may be directly generated from waveforms of the same seismic dataset. Further, the initial first arrivals determined from a representative portion of the seismic dataset, when used to train a ML network, provide a ML network that is capable of predicting first arrivals from all the waveforms of the seismic dataset.

Predicting first arrivals for a complete seismic dataset may facilitate various seismic data processing operations, such as, for example, inversion of velocity models. However, determining the initial first arrivals to train the ML network may introduce errors in the process due to the presence of outliers. Performing seismic data processing operations using initial first arrivals with a reduced number of outliers may provide results with higher precision, and thus, higher resolution. Therefore, processing techniques to reduce or remove outliers in first arrivals may assist in improving the quality of all the seismic processing operations.

It is noted that while the methods described herein will be described in the context of seismic datasets in two dimensions, these methods are not limited to these types of seismic datasets. In general, embodiments disclosed herein can be applied to any pre-stack seismic dataset. For example, embodiments disclosed herein can be applied to a collection of shot gathers. One with ordinary skill in the art will appreciate that the methods disclosed herein are applicable to seismic datasets that have undergone any number of pre-processing steps commonly employed in the art.

Because seismic data may contain spatial and lithology information about a subterranean region of interest, a seismic dataset may be used to construct a seismic image of the subterranean region of interest. The resulting seismic image may then be used for further seismic data interpretation, such as in updating the spatial extension of a hydrocarbon reservoir. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

FIG. 1 shows a seismic acquisition system (100) that may be used to acquire a seismic dataset pertaining to a subsurface region of interest (102), in accordance with one or more embodiments. In some cases, the subsurface region of interest (102) may lie beneath a lake, sea, or ocean. In other cases, the subsurface region of interest (102) may lie beneath an area of dry land. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface as refracted seismic waves (110) or reflected seismic waves (114).

Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may be also boundaries between faults, fractures, or groups of fractures within a rock. The geological discontinuities (112) may delineate a hydrocarbon reservoir (104).

At the surface, refracted seismic waves (110) and reflected seismic waves (114) may be detected by seismic receivers (116). Radiated seismic waves (108) that propagate from the seismic source (106) directly to the seismic receivers (116), known as direct seismic waves (122), may also be detected by the seismic receivers (116).

In some embodiments, a seismic source (106) may be positioned at a location denoted (xₛ, yₛ) where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, xᵣ, yᵣ, t). The t-axis delimits the time sample at which the seismic acquisition system (100) activated the seismic source (106) and acquired the seismic dataset by the seismic receivers (116).

Once acquired, the seismic dataset may undergo a myriad of pre-processing steps. These pre-processing steps may include but are not limited to: increasing the signal to noise ratio; applying move-out corrections; organizing or resampling the traces according to a regular spatial pattern (i.e., regularization); and data visualization. One with ordinary skill in the art will recognize that many pre-processing (or processing) steps exist for dealing with a seismic dataset. As such, one with ordinary skill in the art will appreciate that not all pre-processing (or processing) steps can be enumerated herein and that zero or more pre-processing (or processing) steps may be applied with the methods disclosed herein without imposing a limitation on the instant disclosure.

In some instances, seismic processing may reduce five-dimensional seismic datasets produced by a seismic acquisition system (100) to three-dimensional (x,y,t) seismic datasets by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired over different time intervals, such as, for example, in cases where seismic surveys are repeated to obtain time-lapse data. Seismic data may also be pre-processed data, e.g., arranged as a “common shot gather” (CSG) domain, in which waveforms are acquired by different receivers but a single source location. Further, seismic data may also refer to datasets generated via numerical simulations by modeling wave propagation phenomena in the subsurface region of interest (102). The noted seismic data is not intended to be limiting, and any other suitable seismic dataset is intended to fall within the scope of the present disclosure.

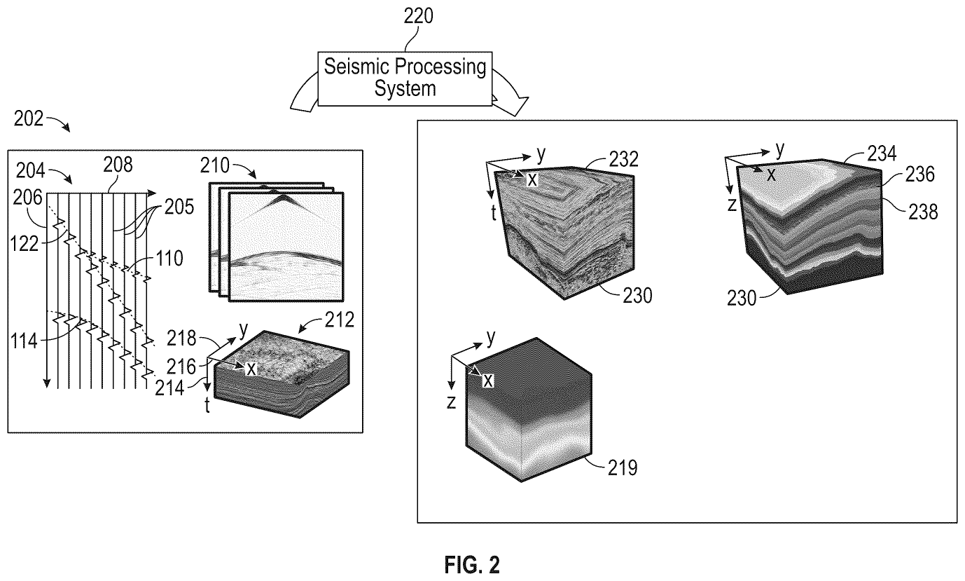

FIG. 2 shows examples of seismic datasets (202) produced by a seismic acquisition system (100) in accordance with one or more embodiments. An example of a CSG (204) illustrates the detection of direct seismic waves (122), refracted seismic waves (110), and reflected seismic waves (114) generated by a single activation of the seismic source (106) and recorded by a several colinear seismic receivers (116). Each seismic receiver (116) may record a time-series representing the amplitude of ground-motion at a sequence of discrete times. This time-series may be denoted or otherwise referred to as a “waveform”, and thus the seismic dataset may be considered as including a plurality of time-space waveforms (205).

In the CSG (204) shown in FIG. 2 the vertical axis indicates the time (206), typically recording time after the activation of the seismic source, and the horizontal axis indicates the offset (208). In some embodiments, direct seismic waves (122), refracted seismic waves (110), and reflected seismic waves (114) may be located in the CSG (204) by their arrival times, also known as first arrivals, i.e., the times instants they are first detected by the seismic receivers (116). The location of a particular type of wave in a seismic dataset acquired in time and space, such as in CSG (204), may be termed as an “arrival” or as an “event”. Events detected in seismic datasets (202) that are related to geological discontinuities (112) including the free surface may be considered as events of seismic reflectivity.

The CSG (204) illustrates how the arrivals are detected at later times by the seismic receivers (116) that are farther from the seismic source (106). In some embodiments, arrivals may have distinctive geometric shapes. For example direct seismic waves (122) in the CSG (204) may be characterized by a straight line, while arrivals of reflected seismic waves (114) may present a hyperbolic shape, as seen in FIG. 2. Refracted seismic waves (110) may be characterized by arrivals in a form that approximates a straight line.

In one or more embodiments, a seismic dataset (202) acquired by a seismic acquisition system (100) may be arranged in a plurality of CSGs (210) to create a 3D seismic dataset, as illustrated in FIG. 2. Alternatively, the seismic dataset (202) may be represented as a “seismic volume” (212) consisting of a plurality of time-space waveforms with a time axis (214), a first spatial dimension (216), and a second spatial dimension (218), where the first spatial dimension (216) and second spatial dimension (218) are orthogonal and span the Earth's surface above the subsurface region of interest (102).

A seismic dataset (202) may be processed by a seismic processing system (220) to generate a seismic velocity model (219) of the subsurface region of interest (102). A seismic velocity model (219) is a representation of seismic velocity at a plurality of locations within a subsurface region of interest (102). Seismic velocity is the speed at which a seismic wave, that may be a pressure-wave or a shear-wave, travel through a medium. Pressures waves are often referred to as “primary-waves” or “P-waves”. Shear waves are often referred to a “secondary waves” or “S-waves”. Seismic velocities in a seismic velocity model (219) may vary in vertical depth, in one or more horizontal directions, or both. Layers of rock may be created from different materials or created under varying conditions. Each layer of rock may have different physical properties from neighboring layers and these different physical properties may include seismic velocity. The seismic processing system (220) will provide multiple methods of performing velocity analysis, including normal moveout analysis, iterative Kirchhoff time- and depth-migration, tomography, and full waveform inversion.

In some embodiments, a seismic dataset (202) may be processed by a seismic processing system (220) to generate a seismic image (230) of the subsurface region of interest (102). For example, a time-domain seismic image (232) may be generated using a process called seismic migration (also referred to as “migration” herein) using a seismic velocity model (219). In seismic migration, events of seismic reflectivity recorded at the surface are relocated in either time or space to the locations the events occurred in the subsurface. In some embodiments, migration may transform pre-processed shot gathers from a time-domain to a depth-domain seismic image (234). In a depth-domain seismic image (234), seismic events in a migrated shot gather may represent geological boundaries (236, 238) in the subsurface. Various types of migration algorithms may be used in seismic imaging. For example, one type of migration algorithm corresponds to reverse time migration.

Processing a seismic dataset (202) may consist of several key groups of functions, each serving a specific purpose in the processing workflow. For example, the steps may include data injection, the loading, sorting and arrangement of raw seismic data, acquired from various sources such as seismographs or land-based sensors, into the processing system. This data may include seismic waveforms, and may also include well logs, and survey information.

Data quality control is critical in seismic data processing. A seismic processing system (220) employs various tools and techniques to identify and correct any artifacts, noise, or errors in the data. This step ensures the accuracy and reliability of subsequent processing steps.

Further, the raw seismic dataset may be “conditioned”, i.e., the raw seismic dataset is pre-processed to enhance its quality and make it suitable for further analysis. This step may include procedures such as filtering, deconvolution, noise suppression, and signal enhancement.

In addition, data may be “stacked”. Stacking involves combining multiple seismic traces to improve data quality and increase signal-to-noise ratio. This may enhance the identification of subsurface features and reduces random noise interference.

The seismic processing system (220) may provide visualization tools to render the seismic dataset (202) in a visual format, enabling geoscientists to analyze, interpret, and perform visual quality control more effectively. This can include 2D/3D seismic displays, depth slices, horizon maps, and virtual reality visualization.

The final step involves generating reports and documenting the results of the seismic processing workflow. This includes recording the processing parameters, interpretation results, and any uncertainties or limitations associated with the data processing. The seismic processing system (220) is used to perform these groups of steps for even a small commercial seismic survey.

The seismic processing system (220) may consist of various hardware components that work together to process and analyze seismic dataset (202). Seismic processing may require significant computational power and storage capacity. High-performance servers and workstations are used to handle the massive amount of seismic dataset (202) and perform complex processing algorithms efficiently. A seismic dataset (202) can be massive, reaching terabytes or even petabytes in size. Reliable and high-capacity storage systems, such as Network Attached Storage (NAS) or Storage Area Networks (SAN), are utilized to store and manage the seismic dataset (202) effectively. In some cases, where processing demands are extremely high, the seismic processing system (220) may utilize cluster systems. Clusters are groups of interconnected computers or servers that work together to distribute the processing workload, enabling parallel processing and faster data analysis. A robust and high-speed network infrastructure allows seamless data transfer between different components of the seismic processing system (220). This ensures efficient communication and data sharing, especially in multi-node or distributed processing environments.

The seismic processing system (220) may use GPUs for accelerating the computation of seismic processing algorithms. Their parallel processing capabilities significantly speed up tasks such as migration, inversion, and visualization. Despite advances in storage technology, data on tapes is still often used for long-term archiving and backup purposes. Tape systems provide high-capacity, cost-effective, and reliable storage solutions for seismic data. Various peripherals such as monitors, keyboards, mice, network switches, uninterruptible power supply (UPS), and backup power generators complete the hardware setup of a seismic processing system. These peripherals ensure smooth operation, user interaction, and data integrity.

The software/firmware are at least as integral a part of the seismic processing system (220) as the hardware components and a seismic processing system (220) equipped with a software program is at least as distinctively different from other seismic processing systems without the software program as a seismic processing system with GPUs is different from one without GPUs.

As illustrated in FIG. 2, processing of a seismic dataset (202) may generate a seismic image (230) that may reveal the three-dimensional geometry of a subsurface region of interest (102). In particular, the geological boundaries (236, 238) may delineate a hydrocarbon reservoir (104). It is then apparent that the accuracy of a seismic image (230) has important implications in the planning of hydrocarbon search and production. A seismic image (230) of high resolution may be obtained if densely-recorded data are acquired by using closely-spaced seismic sources (106) and seismic receivers (116). For example, seismic waves with a bandwidth extending up to 100 Hz or more may resolve thin features of a subsurface region of interest (102).

However, a seismic dataset (202) may contain noise or vibration energy that is often unrelated to the geological features of the subsurface of interest (102). Noise in a seismic dataset (202) may arise from human activities and other natural surficial sources such as oceans, rivers and atmospheric phenomena. Noise in a seismic dataset (202) may be also related to seismic waves reflected at the surface, trapped waves, scattered waves or any kind of seismic energy that is not related to the geological features of interest. Acquisition and processing operations of a seismic dataset (202) may also introduce errors that can be considered as seismic noise. Denoising operations such as filtering are commonly performed in processing a seismic dataset (202).

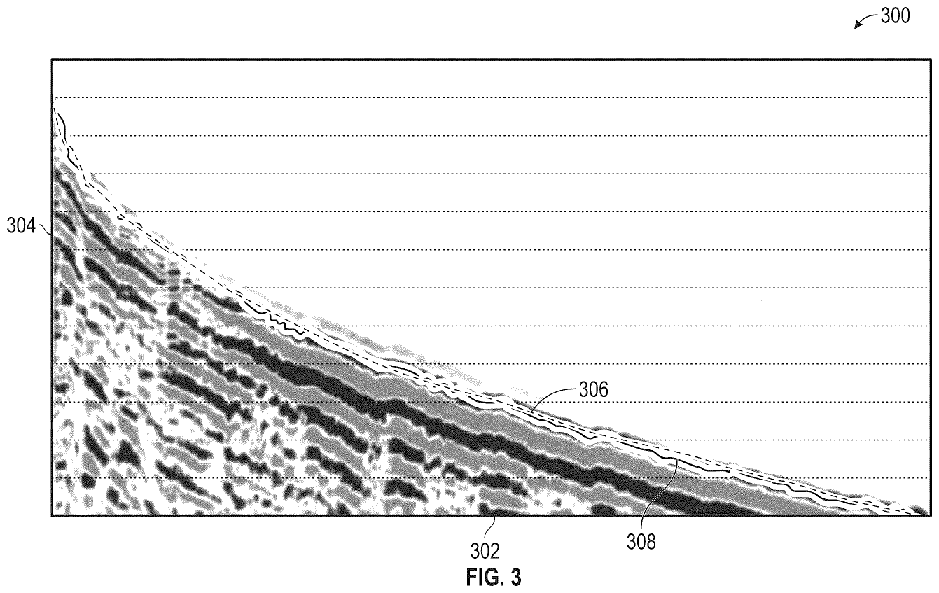

One of the steps employed early in the processing of seismic data (202) is the picking of the arrival-time of a first arriving event for each waveform, which may be referred to as a “first arrival”. FIG. 3 shows a two-dimensional common-shot-gather (CSG) of seismic data (300). In FIG. 3 the abscissa (horizontal axis) indicates a horizontal spatial coordinate (302), and the vertical axis is time, t (304). The dotted line running from left to right across the plot indicates the first arrivals (306) identified by manual picking. In addition, the continuous solid line running from left to right across the plot indicates first arrivals (308) that are obtained after the manual picked first arrivals (306) are “snapped” to the closest maximum or minimum waveform amplitude in a range of +/−32 ms, i.e., the manual pick is replaced or updated with the travel time associated with the closest maximum or minimum values provided those values lie within the range. FIG. 3 illustrates uncertainties in determining first arrivals depending on the methods used, and how arrival picking methods may be affected by the interference of outliers.

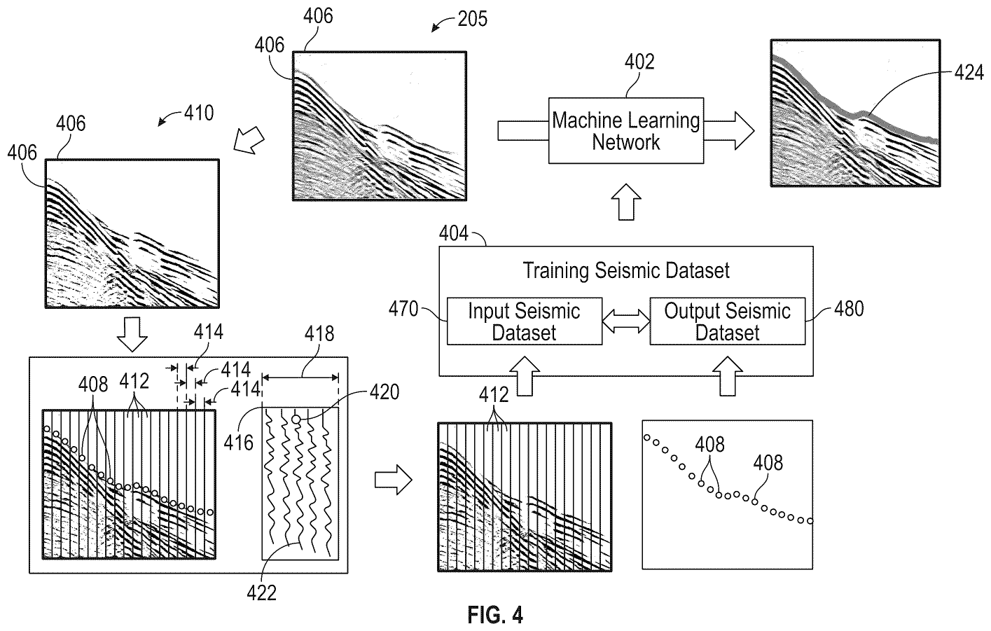

FIG. 4 illustrates an example of a method for determining first arrivals from a seismic dataset (202), in accordance with one or more embodiments. The method of FIG. 4 is based on processing a plurality of time-space waveforms (205) with a trainable machine-learning (ML) network (402) that is trained with a training seismic dataset (404) based on the plurality of time-space waveforms (205). The plurality of time-space waveforms (205) is organized in a data domain (406), such as, for example, a shot domain, a receiver domain, or a common-depth-point domain.

More specifically, the training seismic dataset (404) may include a plurality of initial first arrivals (408) that are obtained by processing the plurality of time-space waveforms (205). First a training waveform set (410) may be generated from a subset of the plurality of time-space waveforms (205). The training waveform set (410) may be organized in the same data domain (406) as the plurality of time-space waveforms (205), and thus the training waveform set (410) may be considered as a sparse representation of the plurality of time-space waveforms (205). Then, a plurality of training subsets (412) may be obtained by partitioning the spatial domain (406) in training bins (414). Each training subset (416) is associated with a particular training bin (418).

The plurality of first arrivals (408) may be generated by determining an initial first arrival (420) for each training subset (416). The initial first arrival (420) may be determined by manual picking or any other automated procedure for arrival picking. Furthermore, the initial first arrival (420) may be determined, for example, picking a first arrival from at least one time-space waveform (422) of the training subset (416). In another example, the initial first arrival (420) may be determined using several time-space waveforms of the training subset (416).

The ML network (402) may be trained with a training seismic dataset (404) that may include at least an input seismic dataset (470) and an output seismic dataset (480). In some embodiments the input seismic dataset (470) may include the plurality of training subsets (412), and the output seismic dataset (480) may include the plurality of initial first arrivals (408). Typically, the seismic dataset (202) may be recorded or simulated (in the case of the input seismic dataset) or predicted (in the case of the output seismic dataset). The trained ML network (402) may then be applied to the plurality of time-space waveforms (205) to predict a plurality of predicted first arrivals (424).

Machine-learning (ML), broadly defined, is the extraction of patterns and insights from data. The phrases “artificial intelligence”, “machine-learning”, “deep-learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. The term machine-learning will be adopted herein. However, one skilled in the art will recognize that the concepts and methods detailed hereafter are not limited by this choice of nomenclature.

ML networks types may include, but are not limited to, generalized linear models, Bayesian regression, random forests, and deep models such as neural networks, convolutional neural networks, and recurrent neural networks. ML network types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. It is noted that in the context of machine-learning (ML), the regularization of a ML network (402) refers to a penalty applied to the loss function of the ML network (402) and should not be confused with the regularization of a seismic dataset. Commonly, in the literature, the selection of hyperparameters surrounding a ML network (402) is referred to as selecting the model “architecture”.

In some embodiments, once a ML network (402) type and hyperparameters have been selected, the ML network (402) is “trained” to perform a task. In some implementations, the ML network (402) is trained using supervised learning. A training seismic dataset (404) for supervised learning consists of pairs of input and output seismic datasets. The output seismic datasets (480) represent desired outputs, upon processing the input seismic datasets (470). During training, the ML network (402) processes at least one input seismic dataset (470) from the training seismic dataset (404) and produces at least one predicted dataset. Each predicted dataset is compared to the output seismic dataset (480) associated to the input seismic dataset (470). The comparison of the predicted dataset to the output seismic dataset (480) may be performed in an iterative manner until a termination criterion is satisfied, and the ML network (402) may be said to be trained.

In accordance with one or more embodiments, the ML network (402) type may be a convolutional neural network (CNN). A CNN may be more readily understood as a specialized neural network (NN). One with ordinary skill in the art will recognize that any variation of the NN or CNN (or any other ML network) may be employed without departing from the scope of this disclosure. Further, it is emphasized that the following discussions of a NN and a CNN are basic summaries and should not be considered limiting.

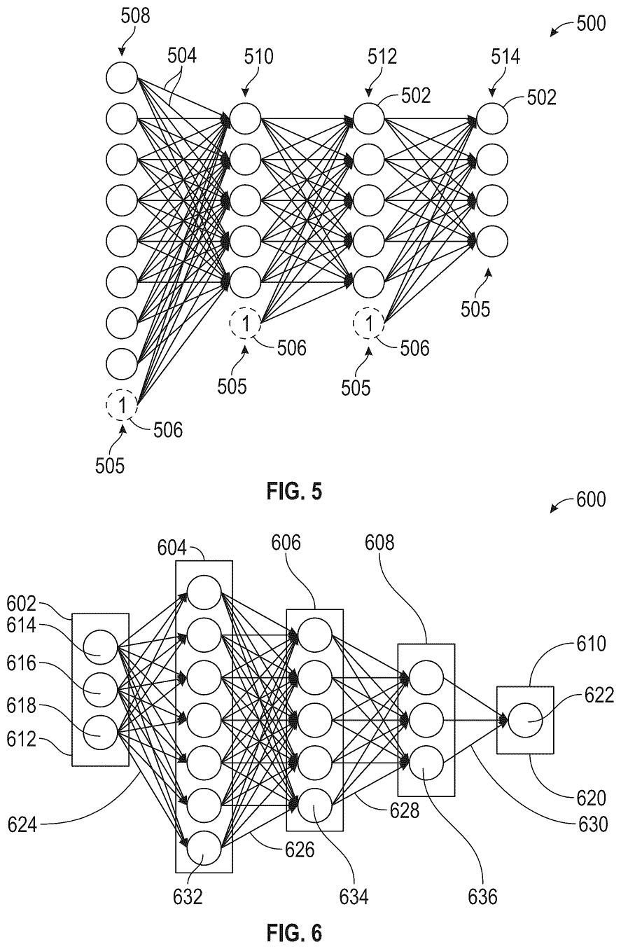

A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer”. Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep-learning method”. In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters”. While training a neural network (500), numerical values are assigned to each edge (504). Additionally, every node (502) is associated with a numerical variable and an activation function. Activation functions are not limited to any functional class, but traditionally follow the form:

$$A = f ( {\sum }_{i ∈ ( i n coming )} [ {( node value )}_{i} {( edge value )}_{i} ] ) \qquad Equation ( 1 )$$

where i is an index that spans the set of “incoming” nodes (502) and edges (504) and f is a user-defined function. Incoming nodes (502) are those that, when viewed as a graph (as in FIG. 5), have directed arrows that point to the node (502) where the numerical value is being computed. Some functions for ƒ may include the linear function ƒ (x)=x, sigmoid function ƒ=1/[1+exp (−x)], and rectified linear unit function ƒ (x)=max (0,x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training, the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output.

A training seismic dataset (404) is provided to the neural network (500). A training seismic dataset (404) consists of pairs consisting of an input seismic dataset (470) and an output seismic dataset (480). For example, the input seismic dataset (470) may include the plurality of training subsets (412), and the output seismic dataset (480) may include the plurality of initial first arrivals (408). Each neural network (500) predicted dataset is compared to the associated output seismic dataset (480). The comparison of the neural network (500) predicted dataset to the output seismic dataset (480) is typically performed by a so-called “loss function”; although other names for this comparison function such as “error function”, “misfit function”, and “cost function” are commonly employed. Many types of loss functions are available, such as the mean-squared-error function, the Huber loss function, however, the general characteristic of a loss function is that the loss function provides a numerical evaluation of the similarity between the neural network (500) output and the associated target. The loss function may also be constructed to impose additional constraints on the values assumed by the edges (504), for example, by adding a penalty term, which may be physics-based, or a regularization term (not be confused with regularization of seismic data).

Generally, the goal of a training procedure is to alter the edge (504) values to promote similarity between the neural network (500) output and associated target over the training seismic dataset (404). Thus, the loss function is used to guide changes made to the edge (504) values, typically through a process called “backpropagation”. While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (504) values are no longer intended to be altered, the neural network (500) is said to be “trained.”

A CNN is similar to a neural network (500) in that it can technically be graphically represented by a series of edges (504) and nodes (502) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Images have such a structural relationship. A seismic dataset may be organized and visualized as an image. Consequently, a CNN is an intuitive choice for processing seismic data (202).

A structural grouping, or group, of weights is herein referred to as a “filter”. The number of weights in a filter is typically much less than the number of inputs, where here the number of inputs refers to the number of pixels in an image or the number of trace-time (or trace-depth) values in a seismic dataset. In a CNN, the filters can be thought as “sliding” over, or convolving with, the inputs to form an intermediate output or intermediate representation of the inputs which still possesses a structural relationship. Like unto the neural network (500), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening”. The flattened representation may be passed to a neural network (500) to produce a final output. Note, that in this context, the neural network (500) is still considered part of the CNN. Like unto a neural network (500), a CNN is trained, after initialization of the filter weights, and the edge (504) values of the internal neural network, if present, with the backpropagation process in accordance with a loss function.

Turning to FIG. 6, FIG. 6 shows an example of a deep learning neural network in accordance with one or more embodiments. The deep learning neural network (600) in FIG. 6 is characterized by its input layer (602), three hidden layers (604, 606, 608), and its output layer (610). In this example, the deep learning neural network (600) receives as input data (612) three waveforms (614, 616, 618) of a training subset (416) and computes as output data (620) a first arrival (622) that is associated with waveform (616). As discussed for FIG. 5, each layer of the deep learning neural network (600) is connected to the next layer by edges (624, 626, 628, 630).

The input data (612) are combined with the edges (624) and a Relu (Rectified Linear Unit) activation function is applied to the result of the combination to obtain the first hidden layer nodes (632). An activation function may be used to provide a non-linear property to the deep learning neural network (600). Without non-linearity, the deep learning neural network (600) could only compute linear mappings from the input data (612) to the output data (620). In order to obtain good prediction for complex training data, a deep learning neural network (600) may approximate non-linear relationships between input data (612) and output data (620). The more complex the training data, the more “non-linear” the mapping from input data (612) to output data (620) may be. In some embodiments, the Relu activation function provides a linear mapping for incoming nodes greater than zero, and zero values otherwise. This Relu activation function is a non-saturating function and as a result, accelerates convergence of operations.

As illustrated in FIG. 6, the first hidden layer (604) becomes the input of another sequence, and the first hidden layer nodes (632) are combined with edges (626) and a sigmoid activation function is applied to the results of the combination to obtain the second hidden layer nodes (634). The sigmond function maps incoming nodes to a range between 0 and 1 and it saturates near 0 and near 1. Continuing with the propagation in the deep learning neural network (600), the second hidden layer nodes (634) are combined with edges (628) and a Selu (Scaled Exponential Linear Unit) activation function is applied to the results of the combination to obtain the third hidden layer nodes (636). The Selu activation function is a self-normalizing function, and because it can give negative values, it allows results that converge to a zero mean and a unit variance. The deep learning neural network (600) may therefore converge faster. The output data (620) generated by the deep learning neural network (600) is then obtained by combining the third hidden layer nodes (636) with edges (630).

The output o of a neural network can be expressed as a nonlinear function h of the input i and of the network hyperparameters (weights and biases) θ:

$$o = h ( i , θ ) \qquad ( 1 )$$

The previous equation can be used to train the network for an inverse problem by assuming the input dₜ and the output mₜ are known, and minimizing a least squares deep learning (DL) objective function ϕ_{l,m} (i.e., loss function) over the network hyperparameters θ

$${ϕ}_{l , m} = {‖ {H}_{θ}^{†} {d}_{t} - {m}_{t} ‖}_{{L}_{2}}^{2} \qquad ( 2 )$$

where the term H_{θ}^{†} is a pseudoinverse operator parameterized by θ. The loss function ϕ_{l,m} is minimized to obtain an optimized set of network hyperparameters θ. The pseudoinverse operator H_{θ}^{†} parameterized by θ is optimized to minimize the discrepancy between predicted models with current network hyperparameters θ and the corresponding known models provided for the training (mₜ). The network hyperparameters θ may be selected by a user or may be identified during training using a set of data similar to the training seismic dataset (404) known as a validation dataset. A testing phase may be also added to further refine and generalize the network hyperparameters θ. In the testing phase the optimized pseudoinverse operator H_{θ}^{†} is used to predict the models using a testing dataset. The procedure may be iterated through additional loss function evaluation and parameter optimization until a stopping criterion, or multiple stopping criteria are reached.

In some embodiments, optimization may be performed using Adaptive Moment Estimation (Adam). The Adam optimization algorithm computes adaptive learning rates for each parameter and stores the first and second moments of the gradients. The parameters of the deep learning neural network (600) are then updated using the first and second moments of the gradients, and the learning rate is adapted. The first moment is the mean of the gradients, and the second moment is the uncentered variance of the gradients. The Adam optimization algorithm may be summarized as follows: 1) initialize the learning rate and the weights (or edges), 2) compute gradients with respect to the loss function using backpropagation, 3) compute the moving average of the gradient and the squared gradient, 4) compute the bias-corrected moving averages, and 5) update the network weights using the bias-corrected averages. Updating the learning rate adaptively provides a different learning rate for each parameter, which is useful in case some parameters are more sensitive than others.

The trained ML network (402) may then be used to predict the output mi from the plurality of time-space waveforms d_{obs} through the optimized pseudoinverse operator H_{θ}^{†}:

$${m}_{l} = {H}_{θ}^{†} {d}_{obs} \qquad ( 3 )$$

The predicted model mₗ can be embedded in a denoising or filtering scheme, where the data dₜ represents a plurality of time-space waveforms (205) and the model mₜ represents the plurality of predicted first arrivals (424).

While an embodiment using a CNN for the ML network (402) has been suggested, one skilled in the art will appreciate that the instant disclosure is not limited to this ML network type. ML network types such as a random forest, visual transformers (ViTs), or non-parametric methods such as K-nearest neighbors or a Gaussian process may be readily inserted into this framework and do not depart from the scope of this disclosure.

In some embodiments, with a ML network type and associated architecture selected, the ML network (402) is trained using one or more input seismic datasets (470) and one or more output seismic datasets (480). Each input seismic dataset (470) may have an associated output seismic dataset (480). For example, the input seismic dataset (470) may include the plurality of training subsets (412), and the output seismic dataset (480) may include the plurality of initial first arrivals (408). During training, the input seismic dataset (470) may be provided to the ML network (402). The ML network (402) may process the input seismic dataset (470) and produce a predicted output. The predicted output may be compared to the associated output seismic dataset (480). In some embodiments, during training, the ML network (402) is adjusted such that the predicted output, upon receiving one or more input seismic datasets (470), is similar to the output seismic datasets (480).

Once the ML network (402) is trained, a subset of the plurality of time-space waveforms and its corresponding plurality of initial first arrivals may form a validation dataset and may be processed by the trained ML network (402) for validation. The predicted dataset is then compared to the associated output seismic datasets (480) of the validation set. Thus, the performance of the trained ML network (402) may be evaluated. An indication of the performance of the ML network (402) may be acquired by estimating the generalization error of the trained ML network (402). The generalization error is estimated by evaluating the performance of the trained ML network (402), after a suitable model has been found on the testing dataset. One with ordinary skill in the art will recognize that the training procedure described herein is general and that many adaptions can be made without departing from the scope of the present disclosure. For example, common training techniques, such as early stopping, adaptive or scheduled learning rates, and cross-validation may be used during training without departing from the scope of this disclosure.

According to one or more embodiments, the trained ML network (402) may be retrained using transfer learning to process seismic data (202) of different type or domain. Transfer learning may be performed, for example, by using the values of the edges (504) of the trained ML network (402) as initial values of the ML network (402) to be trained with different seismic data. Training time may be significantly reduced by making use of transfer learning.

The plurality of predicted initial arrivals (424) obtained with the ML network (402) may then be used by the seismic processing system (220) into a number of data processing operations such as for example, generation of a velocity model, and generation of a seismic image. In particular, a seismic image may assist in identifying geological boundaries (236, 238) and other geological objects, such as faults. If a seismic image (230) indicates the potential presence of hydrocarbons in the subsurface region of interest (102), a wellbore (118) may be planned using a wellbore planning system. Further, a drilling system may drill a wellbore (118) to confirm the presence of those hydrocarbons. The seismic image may also assist in identifying shallow hazards, such as sinkholes and gas pockets.

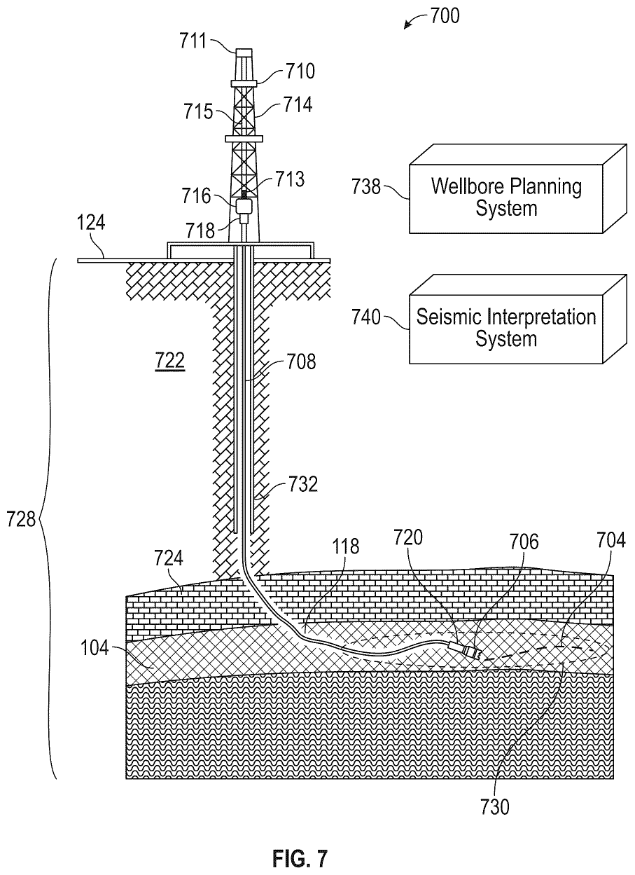

FIG. 7 shows a drilling system (700) in accordance with one or more embodiments. As shown in FIG. 7, a wellbore (118) following a wellbore trajectory (704) may be drilled by a drill bit (706) attached by a drillstring (708) to a drilling rig (710) located on the surface (124) of the earth. The drilling rig (710) may include framework, such as a derrick (714) to hold drilling machinery. A crown block (711) may be mounted at the top of the derrick (714), and a traveling block (713) may hang down from the crown block (711) by means of a cable (715) or drilling line. One end of the cable (715) may be connected to a drawworks (not shown), which is a reeling device that may be used to adjust the length of the cable (715) so that the traveling block (713) may move up or down the derrick (714).

A top drive (716) provides clockwise torque via the drive shaft (718) to the drillstring (708) in order to drill the wellbore (118). The drillstring (708) may comprise a plurality of sections of drillpipe attached at the uphole end to the drive shaft (718) and downhole to a bottomhole assembly (“BHA”) (720). The BHA (720) may be composed of a plurality of sections of heavier drillpipe and one or more measurement-while-drilling (“MWD”) tools configured to measure drilling parameters, such as torque, weight-on-bit, drilling direction, temperature, etc., and one or more logging tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124) using any suitable telemetry system known in the art. The BHA (720) and the drillstring (708) may include other drilling tools known in the art but not specifically shown.

The wellbore (118) may traverse a plurality of overburden (722) layers and one or more formations (724) to a hydrocarbon reservoir (104) within the subterranean region (728), and specifically to a drilling target (730) within the hydrocarbon reservoir (104). The wellbore trajectory (704) may be a curved or a straight trajectory. All or part of the wellbore trajectory (704) may be vertical, and some parts of the wellbore trajectory (704) may be deviated or have horizontal sections. One or more portions of the wellbore (118) may be cased with casing (732) in accordance with a wellbore plan.

To start drilling, or “spudding in” the well, the hoisting system lowers the drillstring (708) suspended from the derrick (714) towards the planned surface location of the wellbore (118). An engine, such as an electric motor, may be used to supply power to the top drive (716) to rotate the drillstring (708) through the drive shaft (718). The weight of the drillstring (708) combined with the rotational motion enables the drill bit (706) to bore the wellbore (118).

The drilling system (700) may be disposed at and communicate with other systems in the well environment, such as a seismic processing system (220), a seismic interpretation system (740), and a wellbore planning system (738). The drilling system (700) may control at least a portion of a drilling operation by providing controls to various components of the drilling operation. In one or more embodiments, the drilling system (700) may receive well-measured data from one or more sensors and/or logging tools arranged to measure controllable parameters of the drilling operation. During operation of the drilling system (700), the well-measured data may include mud properties, flow rates, drill volume and penetration rates, rock physical properties, etc.

A seismic interpretation system (740) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs.

Interpreters may pick and interpret key geological horizons within seismic data to identify stratigraphic layers, boundaries, and structural features. Horizon interpretation tools and workflows allow for the accurate extraction of geological information from seismic volumes. A seismic interpretation system (740) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (740) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (740) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

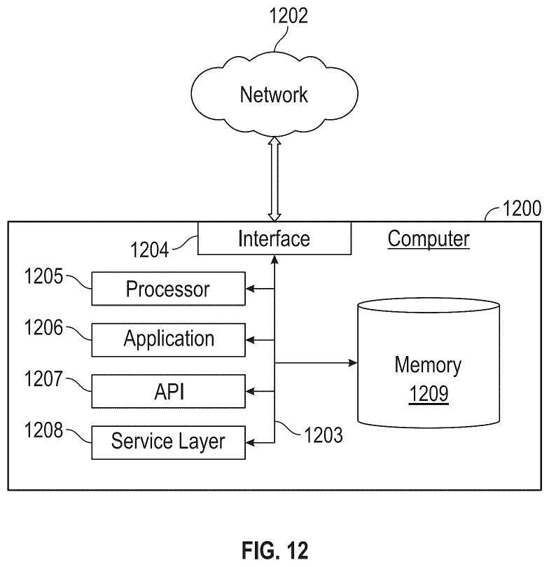

The seismic interpretation system (740) is an important tool for geoscientists involved in exploration and production activities, helping them make informed decisions about drilling locations, optimize production strategies, and understand complex subsurface geological structures. The seismic interpretation system (740) may be a specialized computer system used by geoscientists and seismic interpreters for analyzing and interpreting seismic data. The seismic interpretation system (740) may be implemented on a computing device such as that shown in FIG. 12.

Seismic interpretation involves intensive tasks like data visualization, horizon picking, attribute analysis, and 3D modeling. A high-performance seismic interpretation system (740) with a powerful processor, ample memory, and a high-resolution display is necessary to handle these computationally demanding tasks efficiently. Dedicated GPUs allow real-time rendering of seismic data and enable smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (740) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (740) often requires network connectivity to access centralized data repositories, collaborate with colleagues, and share interpretation results. A robust network infrastructure with fast Ethernet or fiber connections ensures smooth data transfer and collaboration capabilities.

Peripherals like keyboards, mice, and graphics tablets enable efficient interaction with data and software interfaces. Additionally, color-calibrated and high-accuracy input devices enhance the precision of interpretation tasks like picking horizons or drawing geological features. The seismic interpretation system (740) may have backup solutions in place to protect valuable data from loss or damage. Automated backup systems, external storage devices, or network-attached storage (NAS) can be utilized to ensure data safety. In some cases, seismic interpreters may need remote access to the seismic interpretation system (740) or collaborate with colleagues remotely. Setting up remote access capabilities, such as Virtual Private Networks (VPNs) or remote desktop solutions, allows interpreters to work from different locations and share their work effectively. The seismic interpretation system (740) may be customized to meet the needs of interpreters and the specific requirements of projects. The hardware specifications may vary based on factors like the complexity of interpretations, the size of datasets, and the software tools utilized.

In some embodiments, the rock physical properties may be used by a seismic interpretation system (740) to help determine a location of a hydrocarbon reservoir (104). In some implementations, the rock physical properties and other subterranean features may be represented in a seismic image (230) that may be transferred from the seismic processing system (220) to the seismic interpretation system (740). Knowledge of the existence and location of the hydrocarbon reservoir (104) and the seismic image (230) may be transferred from the seismic interpretation system (740) to a wellbore planning system (738). The wellbore planning system (738) may use information regarding the hydrocarbon reservoir (104) location to plan a well, including a wellbore trajectory (704) from the surface (124) of the earth to penetrate the hydrocarbon reservoir (104). In addition, to the depth and geographic location of the hydrocarbon reservoir (104), the planned wellbore trajectory (704) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (704) may be transferred to the drilling system (700) described in FIG. 7. The drilling system (700) may drill the wellbore (118) along the planned wellbore trajectory (704) to access the drilling target (730) in the hydrocarbon reservoir (104).

The wellbore planning system (738) is used in the oil and gas industry for designing and planning drilling operations. It assists drilling engineers and teams in making strategic decisions related to wellbore placement, casing design, trajectory planning, and well path optimization. The wellbore planning system (738) allows drilling engineers to visualize and interact with wellbore data in a 3D environment. It provides a graphical representation of the planned well trajectory, existing well paths, geological formations, and potential hazards.

The wellbore planning system (738) integrates geological models, well logs, seismic data, and other subsurface information to facilitate the creation of accurate and realistic wellbore plans. By incorporating geological models, drilling engineers can optimize well placement in reservoir targets and avoid geohazards. Furthermore, the wellbore planning system (738) may assist in designing optimal well trajectories based on reservoir targets, geologic constraints, and drilling objectives. Engineers can define well paths that maximize drilling efficiency, reach specific targets (horizontal or vertical), and account for geological formations and structural complexities.

The wellbore planning system (738) incorporates collision-avoidance algorithms to assess potential collision risks between nearby wells, salt bodies, or other subsurface infrastructure. By considering uncertainties in subsurface data and drilling conditions, the wellbore planning system (738) may assess collision probabilities for planned well paths. This analysis helps in quantifying risks associated with collision potential and improving well placement decisions. The wellbore planning system (738) provides real-time alerts to prevent wellbore collisions and maintain drilling safety.

The wellbore planning system (738) helps drilling engineers in designing casing strings and selecting appropriate tubulars based on the wellbore conditions, planned drilling operations, and regulatory requirements. It considers factors such as pressure, temperature, well depth, formation properties, and casing load capacity. Furthermore, the wellbore planning system (738) performs torque and drag analysis to evaluate the forces and stresses acting on the drillstring during drilling operations. This analysis helps in identifying potential issues such as differential sticking, buckling, or limitations in the drilling equipment. The wellbore planning system (738) may have the capability to integrate real-time drilling data, such as downhole measurements, drilling parameters, and formation evaluation results. This integration allows engineers to monitor the drilling progress, make on-the-fly adjustments to the well plan, and optimize drilling efficiency. Furthermore, the wellbore planning system (738) provides tools for generating reports, exporting data, and documenting drilling plans and decisions. These reports can be shared with regulatory agencies, drilling contractors, and other stakeholders to ensure alignment and compliance throughout the drilling lifecycle.

The wellbore planning system (738) assists drilling engineers in designing optimal well trajectories, minimizing risks, and maximizing drilling efficiency. They integrate various subsurface data sources, perform complex analyses, and provide visualization tools to support informed decision-making in well planning and drilling operations.

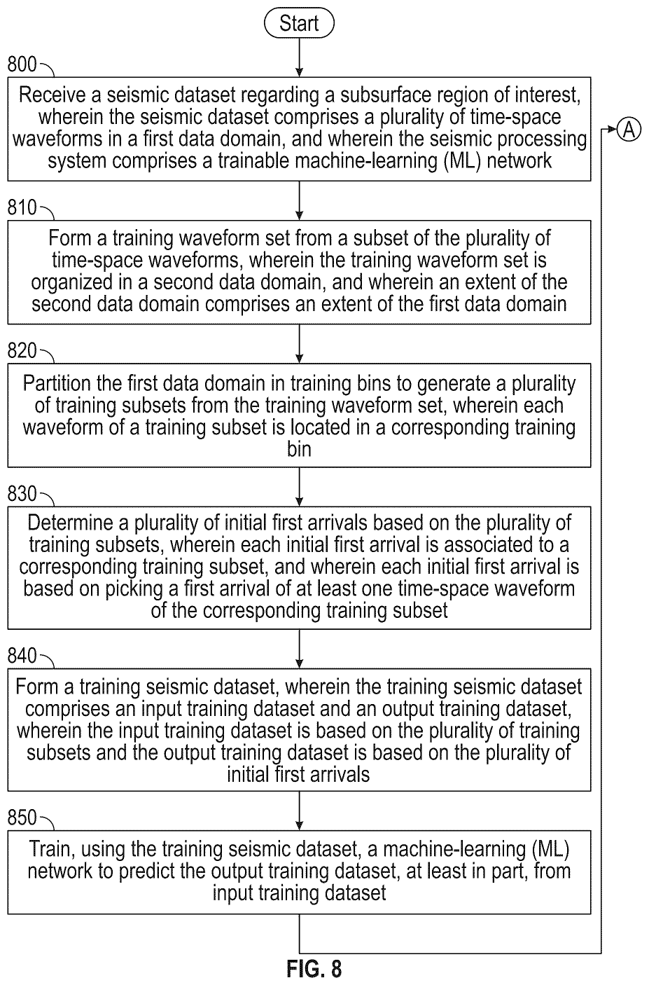

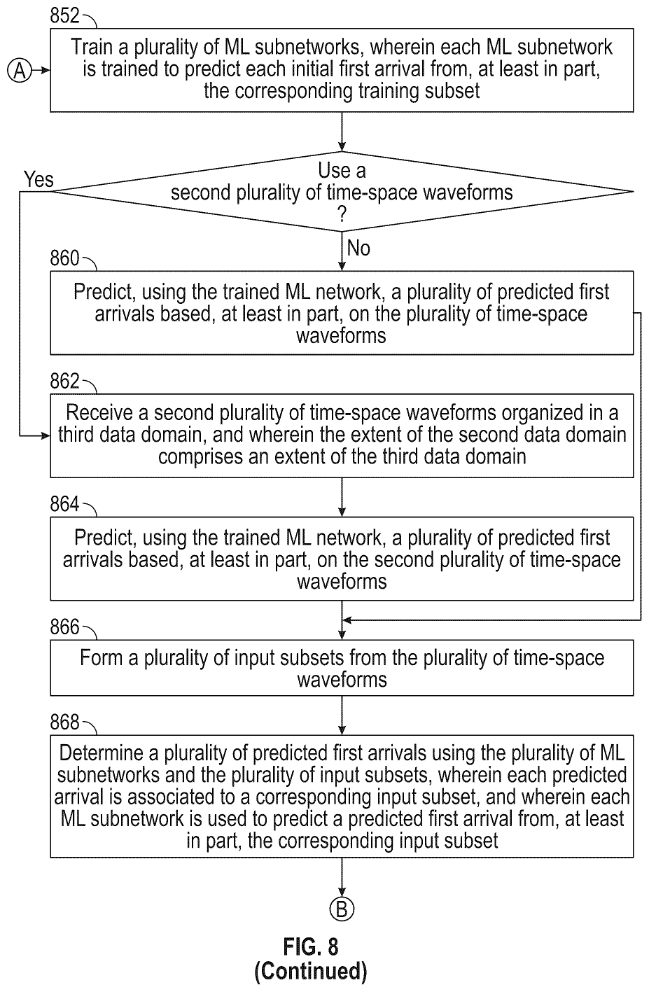

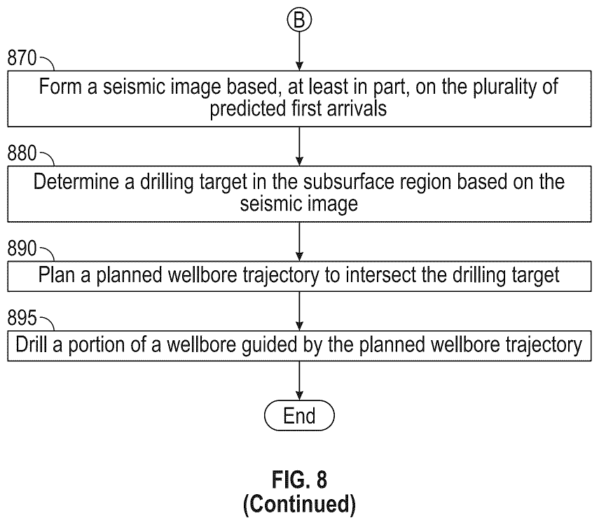

Turning to FIG. 8, FIG. 8 shows a flowchart in accordance with one or more embodiments. Specifically, FIG. 8 describes a general method to generate a plurality of predicted first arrivals (424) from seismic data. While the various blocks in FIG. 8 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 800, seismic data regarding a subsurface region of interest is received by a seismic processing system, in accordance with one or more embodiments. The seismic processing system includes a trainable machine-learning (ML) network. The seismic data (202) includes a plurality of time-space waveforms (205) in a first data domain (406). For example, seismic data (202) may be organized in one or more spatial dimensions (216, 218) and a time axis (214) to form the plurality of time-space waveforms (205). The seismic data (202) may be acquired with a seismic acquisition system (100). In some embodiments, the plurality of time-space waveforms (205) may be obtained with numerical simulations of seismic waves propagating in a model of the subsurface region of interest (102). The plurality of time-space waveforms (205) may be similar to the waveforms described in FIGS. 2 and 3 and the accompanying description. Furthermore, the subsurface region of interest (102) may be a portion of a geological area or volume that includes one or more formations (724) of interest desired or selected for analysis, e.g., for determining location of hydrocarbons or reservoir development purposes.

In some embodiments, the plurality of time-space waveforms (205) may be ordered based on a seismic parameter. The seismic parameter may be, for example, a distance from a common depth point, that is, the common reflection point at depth on a reflector. The plurality of time-space waveforms (205) is then said to be in the “common-depth-point domain”. Another example of the seismic parameter may be an azimuth of a waveform centered on a common midpoint, and the plurality of time-space waveforms (205) is said to be in the “azimuth domain”. Other seismic parameters known to those skilled in the art can be used without departing from the scope of the present disclosure.

In Block 810, a training waveform set is formed from a subset of the plurality of time-space waveforms, in accordance with one or more embodiments. The training waveform set (410) is organized in a second data domain. The extent of the second data domain includes an extent of the first data domain (406). The training waveform set (410) may be considered as a sparse representation of the plurality of time-space waveforms (205). The training waveform set (410) may include, for example, 5% of the plurality of time-space waveforms (205).

In block 820, the first data domain is partitioned in training bins to generate a plurality of training subsets from the training waveform set, in accordance with one or more embodiments. Each waveform of a training subset (416) is located in a corresponding training bin (418). For example, the first data domain may be partitioned by dividing a distance from a common midpoint into various training bins (414) that correspond to different offset ranges. In another example, a complete 360 degree azimuth may be divided into various training bins (414) that correspond to different azimuth angles centered on a common midpoint. Thus, for a particular data domain, azimuthal values (e.g., 30 degrees or 60 degrees) may be used to generate the training bins (414).

In block 830, a plurality of initial first arrivals is determined based on the plurality of training subsets, in accordance with one or more embodiments. Each initial first arrival (420) is associated to a corresponding training subset (416). In addition, each initial first arrival (420) is based on picking a first arrival of at least one time-space waveform (422) of the corresponding training subset (416). All or some of the plurality of initial first arrivals (408) may be determined by manual picking. Picking a first arrival may be also based on a combination of manual picking and snipping to the closest minimum or maximum waveform amplitude. Various first arrival picking methods known in the art, such as for example, those based on automated picking, may be also used, alone or in combination, to determine the plurality of initial first arrivals (420).

In some embodiments, each initial first arrival (420) may be determined by picking a first arrival from one time-space waveform (422). The one time-space waveform (422) may be the central time-space waveform of the corresponding training subset (416). More specifically, each time-space waveform in the corresponding training subset (416) is associated to a spatial coordinate, and the spatial coordinate of the central time-space waveform may be the closest spatial coordinate to the average of the spatial coordinates of all time-space waveforms of the corresponding training subset (416). In other embodiments, each initial first arrival (420) may be determined from multiple time-space waveforms of the corresponding training subset (416). For example, multiple time-space waveforms of the corresponding training subset (416) may be stacked previously to picking the first arrival. In another example, the initial first arrival (420) may be determined from a combination of first arrivals of the multiple time-space waveforms of the corresponding training subset (416). Any other method known to those skilled in the art may be used to determine the initial first arrival (420) from multiple time-space waveforms of the corresponding training subset (416), without departing from the scope of this invention.

In some embodiments, training subsets (412) may be processed and corrected before picking first arrivals. Processing operations include, for example, applying alignment and amplitude correction to each time-space waveform of each training subset (416). Waveform alignment is desirable because it may avoid smearing of phases (leading to loss of frequency) or amplitudes of the time-waveforms are stacked. For example, alignment may be based on differences in offset amongst waveforms within a training bin (418). Stacked waveforms may also display a position-related time delay. Such time delays may become bigger as the physical dimensions (i.e., coverage area) of the training bin (418) increases. In other words, waveforms at slightly different distances from a seismic source may need compensation to account for the differences in travel times. In some embodiments, for example, a Linear Move Out (LMO) is determined for a training bin (418). An LMO value may compensate the difference in location of the training bin (418) for various LMO events such as diving waves that may not be properly corrected for reflected events, especially at a short difference in position.

In Block 840, a training seismic dataset is formed, in accordance with one or more embodiments. The training seismic dataset includes an input training dataset (470) and an output training dataset (480). The input training dataset is based on the plurality of training subsets (412) and the output training dataset is based on the plurality of initial first arrivals (408).

For example, in some embodiments the input training dataset (470) may include the plurality of training subsets (412), and the output training dataset (480) may include the plurality of initial first arrivals (408). In other embodiments the input training dataset (470) may include a first partition of the plurality of training subsets and the output training dataset (480) may include the initial first arrivals corresponding the first partition. The first partition may be, for example, 70% of the plurality of training subsets (412).

By generating the plurality of training subsets (412) and the plurality of initial first arrivals (408) as described in Blocks 720-730 of FIG. 8, each training seismic dataset (404) may include a pair consisting of an input seismic dataset (470) and the accompanying output seismic dataset (480). Each output seismic dataset (480) may be generated directly from the input seismic dataset (470), without making use of modelling processes and assumptions.

In Block 850, a machine-learning (ML) network is trained to predict the output training dataset, at least in part, from input training dataset, in accordance with one or more embodiments. The ML network (402) may be trained to predict first arrivals from given input seismic dataset (470). In accordance with one or more embodiments, the ML network type may be a convolutional neural network (CNN). In some embodiments, training the ML network (402) may include training a plurality of ML subnetworks. Each ML subnetwork may be trained to predict each initial first arrival (420) from the corresponding training subset (416), as shown in Block 852.

As a non-limiting example, a training waveform set (410) may be organized in the offset domain, with a total offset of 3 km. The offset domain may be partitioned into 50 training bins (414) of 60 m each. Thus, any waveform with an offset (or spatial coordinate) between 0 m and 60 m may be grouped in a first training subset, and any waveform with an offset between 60 m and 120 m may be grouped in a second training subset. Once a plurality of training subsets (412) is formed, an initial first arrival (420) may be determined for each of the plurality of training subsets (412). For each initial first arrival (420) and its corresponding training subset (416) a ML subnetwork may be trained. Therefore, in this example 50 different ML subnetworks may be trained based on the training waveform set (410).

The training of each ML subnetwork using a training subset (416) associated with training bin (418), as proposed in the present disclosure, may provide a plurality of different trained ML subnetworks with a spatial dependence, i.e., a dependence on the training bin (418). Each training subset (416) is used independently as input data train the ML subnetwork. This spatial dependence of the trained ML subnetworks may improve the robustness in training and prediction operations. In addition, the spatial dependence of the trained ML subnetworks may add physical constraints resulting in a reduced presence of outliers in the predicted first arrivals (424). Therefore, the prediction phase using the trained ML subnetworks may be performed without imposing physical constraints. When used in seismic datasets with first arrivals difficult to determine, the proposed method may outperform physics-based methods since the ML subnetworks are trained based on different pattern detection for different offsets.

In Block 860, a plurality of predicted first arrivals may be predicted based on the plurality of time-space waveforms, using the trained ML network. In some embodiments, the trained ML network (402) is configured to receive the plurality of time-space waveforms (205) and output the plurality of predicted first arrivals (424). Each of the plurality of time-space waveforms may be associated to a corresponding predicted first arrival. In some embodiments, the trained ML network (402) is further configured to receive a second plurality of time-space waveforms organized in a third data domain, as shown in Block 862. The extent of the second data domain may include the extent of the third data domain. Then the trained ML network (402) may be used to predict the plurality of predicted first arrivals (424) based on the second plurality of time-space waveforms, as shown in Block 864.

In some embodiments, a plurality of input subsets may be formed from the plurality of time-space waveforms, as shown in Block 866. The plurality of input subsets may be formed using the training bins (414). In some embodiments, each waveform of an input subset may be located in the corresponding training bin (418). In other embodiments each of the plurality of input subsets may be formed by grouping a selected waveform with a number of waveforms (for example, 2 or 4 waveforms) adjacent to the selected waveform. Each input subset may then be associated to a training bin containing the spatial coordinate of the selected waveform.

The plurality of ML subnetworks and the plurality of input subsets may be used to determine the plurality of predicted first arrivals (424), as shown in Block 868. Each predicted arrival may be associated to a corresponding input subset, and each ML subnetwork may be used to predict a predicted first arrival from the corresponding input subset. In some embodiments, the ML subnetwork may be used to predict a predicted first arrival for each waveform of the corresponding input subset.

In Block 870, a seismic image is determined based, at least in part, on the plurality of predicted first arrivals (424), in accordance with one or more embodiments. In some embodiments, the seismic data (202) may include a plurality of gathers and each gather may include a plurality of time-space waveforms (205), as illustrated in FIG. 2 and FIG. 3. The plurality of time-space waveforms (205) may be processed to extract a plurality of predicted first arrivals (424). The plurality of predicted first arrivals (424) may be used to generate or update a seismic velocity model (219) and/or a seismic image (230). The seismic image (230) may provide information about the geological discontinuities (236, 238) or reflectors in the subsurface region of interest (102).

Processing to generate a plurality of predicted first arrivals (424) may be performed for one or more gathers of the seismic data (202), and the plurality of processed gathers may then be used by the seismic processing system (220) to generate the seismic image (230). For example, a partial seismic image may be generated for each of the plurality of processed gathers obtaining a plurality of partial seismic images. A stacked seismic image may then be constructed, for example, by summing the partial seismic images.

An accurate seismic velocity model (219) may be useful for the accurate generation of seismic images (230). A seismic velocity model (219) regarding the subsurface region of interest (102) provides an estimate of at least one seismic wave propagation velocity at each location in the depth domain within the subterranean region of interest (102). Typically, a seismic velocity model (219) is specified by at least one seismic velocity for a particular wave type at a plurality of discrete grid points spanning the subsurface region of interest, but other specifications are possible. For example, the seismic velocity model (219) may be defined by a plurality of continuously varying mathematical functions.

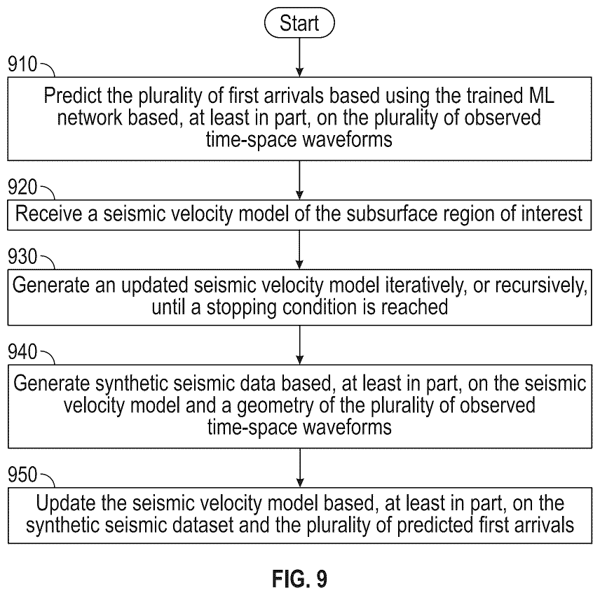

Turning to FIG. 9, FIG. 9 shows an example of a method to update a seismic velocity model, in accordance with one or more embodiments. A seismic velocity model (219) may be constructed by processing observed seismic data including a plurality of observed time-space waveforms. Observed seismic data regarding the subsurface region of interest (102) may be recorded using a seismic acquisition system (100). A seismic processing system (220) may receive the plurality of observed time-space waveforms appertaining to the subsurface region of interest (102). The seismic processing system (220) may the predict the plurality of first arrivals based on the plurality of observed time-space waveforms, as shown in Block 910.

In addition, the seismic processing system (220) may obtain a seismic velocity model (219) of the subsurface region of interest (102), as shown in Block 920. Various types of algorithms may be used in the generation of the seismic velocity model (219). In some embodiments, processing observed seismic data to obtain a seismic velocity model (219) may be considered an inverse problem, where the applied process must determine the subsurface velocity model that resulted in the measured seismic data. Observed seismic data may be processed to form a seismic velocity model, that may be updated iteratively as part of the inversion.

In Block 930 an updated seismic velocity model (219) is generated iteratively, or recursively, until a stopping condition is reached, in accordance with one or more embodiments. Synthetic seismic data may be generated at each iteration to progressively approach or match one or more characteristics of the observed time-space waveforms. In Block 940, the synthetic seismic data is generated based, at least in part, on the seismic velocity model and a geometry of the plurality of observed time-space waveforms, in accordance with one or more embodiments. The synthetic seismic data may include time-space waveforms obtained from numerical simulations of wave propagation within the subsurface region of interest (102). In some embodiments numerical simulations are based on the elastic wave equation, or a simplified version of the elastic wave equation, such as the acoustic wave equation or Helmholtz wave equation, based at least in part on the seismic velocity model. In accordance with one or more embodiments, this modeling or seismic wave propagation and simulation of the seismic waves measured by the seismic receivers (116) may be done by the computer system (1200) of FIG. 12.

The seismic synthetic data may be generated using the geometry of the observed time-space waveforms to allow the comparison of observed and simulated arrival times. For example, the locations of receivers relative to the source may be the same for the observed time-space waveforms and the synthetic seismic data. Furthermore, the receivers of the seismic synthetic data may span the same range of midpoints and offsets as the observed time-space waveforms.

In Block 950 the seismic velocity model is updated based, at least in part, on the synthetic seismic dataset and the plurality of predicted first arrivals (424), in accordance with one or more embodiments. Synthetic first arrivals may be determined from the synthetic seismic data. Further, the plurality of predicted first arrivals (424) obtained from the plurality of observed time-space waveforms and the synthetic first arrivals may be compared using an objective function. Updating the seismic velocity model (219) may be based on the minimization of the objective function.

In some embodiments, the objective function may be used to check model convergence. The check for convergence may include evaluating the objective function and determining if the value of the objective function is below a predetermined value, where the predetermined value quantifies a satisfactory matching between the predicted first arrivals (424) and the synthetic first arrivals. Alternatively, convergence may be determined by the iteration at which the value of the objective function ceases to decrease by more than a predetermined amount between the current iteration and the previous iteration.

In some embodiments, convergence may be considered as the stopping condition to be reached by the iterative process. If the updating process has converged the updated seismic velocity model may be designated as the final updated seismic velocity model, and the updating process is terminated. If the updating process has not converged, then a new iteration is performed to generate a new updated seismic velocity model by repeating steps in Blocks 830-850.

Returning to FIG. 8, in Block 880 of FIG. 8, a drilling target in the subsurface region may be determined based on the seismic image (230), in accordance with one or more embodiments. The seismic image (230) may be transferred to a seismic interpretation system (740). The seismic interpretation system (740) may use the seismic image (230) to determine the location of a drilling target (730). The location of the drilling target (730) in a wellbore (118) may be based on, for example, an expected presence of gas or another hydrocarbon within a seismic image (230). Locations in a seismic image (230) may indicate an elevated probability of the presence of a hydrocarbon and may be targeted by well designers. On the other hand, locations in a seismic image (230) indicating a low probability of the presence of a hydrocarbon may be avoided by well designers.

In Block 890, a planned wellbore trajectory (704) to intersect the drilling target (730) is planned, in accordance with one or more embodiments. Knowledge of the location of the drilling target (730) and the seismic image (230) may be transferred to a wellbore planning system (738). Instructions associated with the wellbore planning system (738) may be stored, for example, in the memory (1209) within the computer system (1200) described in FIG. 12 below. The wellbore planning system (738) may use the knowledge of the location of the drilling target (730) and of the seismic image (230) to plan a planned wellbore trajectory (704) within the subsurface region of interest (102).

In Block 895, a portion of a wellbore is drilled guided by the planned wellbore trajectory, in accordance with one or more embodiments. The wellbore planning system (738) may transfer the planned wellbore trajectory (704) to the drilling system (700) described in FIG. 7. The drilling system (700) may drill the wellbore (118) along the planned wellbore trajectory (704) to access and produce the hydrocarbon reservoir (104) to the surface (124).

As an illustrative example of the methods, processes, models, and techniques described herein, a plurality of time-space waveforms (205) was acquired, a ML network (402) was trained, and a plurality of predicted first arrivals (424) was generated. Specifically, the plurality of time-space waveforms (205) is the first CSG (300) of FIG. 3. With 75 training bins (414) of 40 m, 75 training subsets (412) were formed from the first CSG (300). Each training subset (416) was used to train a ML subnetwork obtaining effectively 75 trained ML subnetworks. The ML subnetworks were trained with the network architecture shown in FIG. 6.

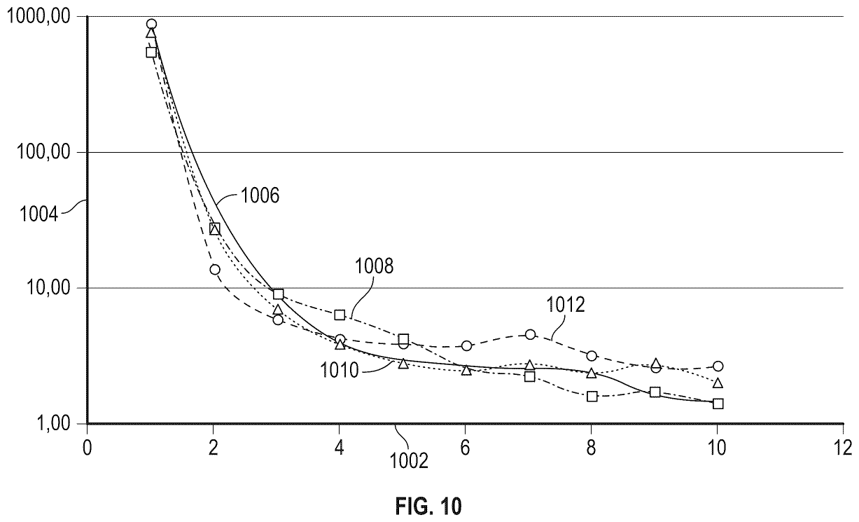

When comparing the initial first arrivals (408) with the predicted first arrivals (424), the ML subnetworks showed a small misfit of 2 ms at the tenth training progression. FIG. 10 illustrates the evolution of the misfit between the initial first arrivals (408) and the predicted first arrivals (424) with training progression. The horizontal axis in FIG. 10 indicates the number of the training progression (1002) and the vertical axis indicates the mean square error (1004) in ms. Curves (1006), (1008), (1010), and (1012) correspond respectively to the first, second, third and fourth trained ML subnetworks. As illustrated in FIG. 10, the reduction of the misfit with training progression is similar for the first four ML subnetworks, even though each ML subnetwork was trained independently based on a training subset.

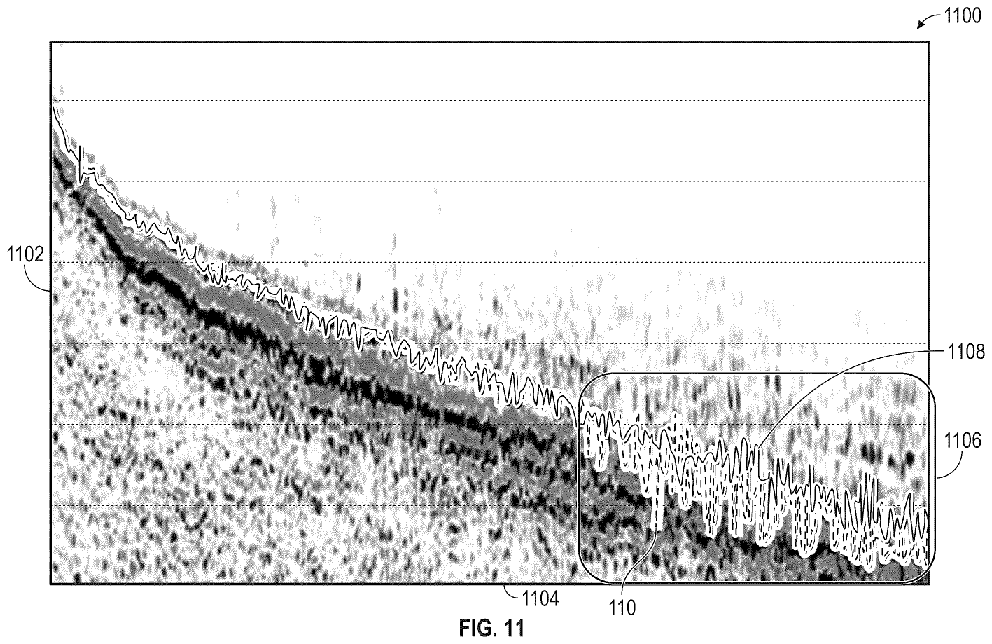

FIG. 11 illustrates predicted first arrivals obtained for a second plurality of time-space waveforms. In the example of FIG. 11, the second plurality of time-space waveforms corresponds to the second CDP gather (11000). However, the ML subnetworks were trained with the training subsets (412) obtained from the first CDP gather (300) of FIG. 3. In FIG. 11 the time is indicated by the vertical axis (1102) and the offset is indicated by the horizontal axis (1104). As seen, the second CDP gather (1100) appears to be more complex and noisier than the first CDP gather (300), in particular in region (1106).

A plurality of input subsets was formed from the second CDP gather (1100) using the training bins (414) used to form the training subsets. The trained ML subnetworks were used to generate the predicted first arrivals (1108) shown in FIG. 11 based on the plurality of input subsets. The results were then compared to first arrivals (1110) that were obtained by manual picking and snipping to the closest maximum or minimum waveform amplitude. As seen in FIG. 11, when compared to first arrivals (1110), the cycling behavior has been considerably reduced in the predicted first arrivals (1108), and the precision in the more complex region (1106) has been enhanced. The predicted first arrivals (1108) illustrate the effectiveness of the proposed method to determine first arrivals in seismic data.

In some embodiments the wellbore planning system (738), the seismic interpretation system (740), and the seismic processing system (220) may each be implemented within the context of a computer system. FIG. 12 is a block diagram of a computer system (1200) used to provide computational functionalities associated with described algorithms, methods, functions, processes, flows, and procedures as described in the instant disclosure, according to an implementation. The illustrated computer (1200) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1200) may include a computer that includes an input device, such as a keypad, keyboard, touch screen, or other device that can accept user information, and an output device that conveys information associated with the operation of the computer (1200), including digital data, visual, or audio information (or a combination of information), or a GUI.

The computer (1200) can serve in a role as a client, network component, a server, a database or other persistency, or any other component (or a combination of roles) of a computer system for performing the subject matter described in the instant disclosure. The illustrated computer (1200) is communicably coupled with a network (1202). In some implementations, one or more components of the computer (1200) may be configured to operate within environments, including cloud-computing-based, local, global, or other environment (or a combination of environments).

At a high level, the computer (1200) is an electronic computing device operable to receive, transmit, process, store, or manage data and information associated with the described subject matter. According to some implementations, the computer (1200) may also include or be communicably coupled with an application server, e-mail server, web server, caching server, streaming data server, business intelligence (BI) server, or other server (or a combination of servers).

The computer (1200) can receive requests over network (1202) from a client application (for example, executing on another computer (1200)) and responding to the received requests by processing the said requests in an appropriate software application. In addition, requests may also be sent to the computer (1200) from internal users (for example, from a command console or by other appropriate access method), external or third-parties, other automated applications, as well as any other appropriate entities, individuals, systems, or computers.

Each of the components of the computer (1200) can communicate using a system bus (1203). In some implementations, any or all of the components of the computer (1200), both hardware or software (or a combination of hardware and software), may interface with each other or the interface (1204) (or a combination of both) over the system bus (1203) using an application programming interface (API) (1207) or a service layer (1208) (or a combination of the API (1207) and service layer (1208). The API (1207) may include specifications for routines, data structures, and object classes. The API (1207) may be either computer-language independent or dependent and refer to a complete interface, a single function, or even a set of APIs. The service layer (1208) provides software services to the computer (1200) or other components (whether or not illustrated) that are communicably coupled to the computer (1200). The functionality of the computer (1200) may be accessible for all service consumers using this service layer (1208). Software services, such as those provided by the service layer (1208), provide reusable, defined business functionalities through a defined interface. For example, the interface may be software written in JAVA, C++, or other suitable language providing data in extensible markup language (XML) format or other suitable format. While illustrated as an integrated component of the computer (1200), alternative implementations may illustrate the API (1207) or the service layer (1208) as stand-alone components in relation to other components of the computer (1200) or other components (whether or not illustrated) that are communicably coupled to the computer (1200). Moreover, any or all parts of the API (1207) or the service layer (1208) may be implemented as child or sub-modules of another software module, enterprise application, or hardware module without departing from the scope of this disclosure.

The computer (1200) includes an interface (1204). Although illustrated as a single interface (1204) in FIG. 12, two or more interfaces (1204) may be used according to particular needs, desires, or particular implementations of the computer (1200). The interface (1204) is used by the computer (1200) for communicating with other systems in a distributed environment that are connected to the network (1202). Generally, the interface (1204) includes logic encoded in software or hardware (or a combination of software and hardware) and operable to communicate with the network (1202). More specifically, the interface (1204) may include software supporting one or more communication protocols associated with communications such that the network (1202) or interface's hardware is operable to communicate physical signals within and outside of the illustrated computer (1200).

The computer (1200) includes at least one computer processor (1205). Although illustrated as a single computer processor (1205) in FIG. 12, two or more processors may be used according to particular needs, desires, or particular implementations of the computer (1200). Generally, the computer processor (1205) executes instructions and manipulates data to perform the operations of the computer (1200) and any algorithms, methods, functions, processes, flows, and procedures as described in the instant disclosure.

The computer (1200) also includes a memory (1209) that holds data for the computer (1200) or other components (or a combination of both) that may be connected to the network (1202). For example, memory (1209) may be a database storing data consistent with this disclosure. Although illustrated as a single memory (1209) in FIG. 12, two or more memories may be used according to particular needs, desires, or particular implementations of the computer (1200) and the described functionality. While memory (1209) is illustrated as an integral component of the computer (1200), in alternative implementations, memory (1209) may be external to the computer (1200).

The application (1206) is an algorithmic software engine providing functionality according to particular needs, desires, or particular implementations of the computer (1200), particularly with respect to functionality described in this disclosure. For example, application (1206) can serve as one or more components, modules, applications, etc. Further, although illustrated as a single application (1206), the application (1206) may be implemented as multiple applications (1206) on the computer (1200). In addition, although illustrated as integral to the computer (1200), in alternative implementations, the application (1206) may be external to the computer (1200).

There may be any number of computers (1200) associated with, or external to, a computer system containing computer (1200), each computer (1200) communicating over network (1202). Further, the term “client,” “user,” and other appropriate terminology may be used interchangeably as appropriate without departing from the scope of this disclosure. Moreover, this disclosure contemplates that many users may use one computer (1200), or that one user may use multiple computers (1200).

In some embodiments, the computer (1200) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
receiving, by a seismic processing system, a seismic dataset regarding a subsurface region of interest, wherein the seismic dataset comprises a plurality of time-space waveforms organized in a first data domain, and wherein the seismic processing system comprises a trainable machine-learning (ML) network; and
using the seismic processing system:
forming a training waveform set from a subset of the plurality of time-space waveforms, wherein the training waveform set is organized in a second data domain, and wherein an extent of the second data domain comprises an extent of the first data domain,
partitioning the first data domain in training bins to generate a plurality of training subsets from the training waveform set, wherein each training subset is associated to a corresponding training bin,
determining a plurality of initial first arrivals based on the plurality of training subsets, wherein each initial first arrival is associated to a corresponding training subset, and wherein each initial first arrival is based on picking a first arrival of at least one time-space waveform of the corresponding training subset,
forming a training dataset, wherein the training dataset comprises an input training dataset and an output training dataset, wherein the input training dataset is based on the plurality of training subsets and the output training dataset is based on the plurality of initial first arrivals, and
training, using the training dataset, the machine-learning (ML) network to predict the output training dataset, at least in part, from the input training dataset.

2. The method of claim 1, wherein training the ML network comprises training a plurality of ML subnetworks, wherein each ML subnetwork is trained to predict each initial first arrival from, at least in part, the corresponding training subset.

3. The method of claim 2, further comprising:
forming a plurality of input subsets from the plurality of time-space waveforms; and
determining a plurality of predicted first arrivals using the plurality of ML subnetworks,
wherein each predicted arrival is associated to a corresponding input subset, and
wherein each ML subnetwork is used to predict a predicted first arrival from, at least in part, the corresponding input subset.

4. The method of claim 3, wherein forming the plurality of input subsets comprises using the training bins, and wherein each waveform of the input subset is located in a corresponding training bin.

5. The method of claim 1, wherein the data domain comprises a common-depth-point domain.

6. The method of claim 1, wherein each time-space waveform of a corresponding training subset is associated to a spatial coordinate, and wherein a spatial coordinate of the at least one time-space waveform is a closest spatial coordinate to an average of the spatial coordinates of all time-space waveforms of the corresponding training subset.

7. The method of claim 2, further comprising:
generating, using the seismic processing system, a seismic image based, at least in part, on the plurality of predicted first arrivals; and
determining, using a seismic interpretation system, a drilling target in the subsurface region based, at least in part, on the seismic image.

8. The method of claim 7, further comprising:
planning, using a wellbore planning system, a planned wellbore trajectory to intersect the drilling target; and
drilling, using a drilling system, a portion of a wellbore guided by the planned wellbore trajectory.

9. The method of claim 1, wherein the ML network comprises a convolutional neural network.

10. The method of claim 1, further comprising:
receiving, by the seismic processing system, a second plurality of time-space waveforms organized in a third data domain, wherein the extent of the second data domain comprises an extent of the third data domain; and
predicting, using the seismic processing system and the trained ML network, a plurality of predicted first arrivals based, at least in part, on the second plurality of time-space waveforms.

11. The method of claim 2, wherein the seismic dataset comprises a plurality of observed time-space waveforms acquired by a seismic acquisition system, and wherein the method further comprises:
predicting the plurality of first arrivals using the trained ML network based, at least in part, on the plurality of observed time-space waveforms;
receiving a seismic velocity model of the subsurface region of interest; and
generating an updated seismic velocity model iteratively, or recursively, until a stopping condition is reached, wherein generating the updated seismic velocity model comprises:
generating a synthetic seismic dataset based, at least in part, on the seismic velocity model and a geometry of the plurality of observed time-space waveforms, and
updating, the seismic velocity model based, at least in part, on the synthetic seismic dataset, the plurality of predicted first arrivals and the plurality of observed time-space waveforms.

12. A system, comprising:
a seismic processing system comprising a trainable machine-learning (ML) network and configured to:
receive a seismic dataset regarding a subsurface region of interest, wherein the seismic dataset comprises a plurality of time-space waveforms organized in a first data domain,
form a training waveform set from a subset of the plurality of time-space waveforms, wherein the training waveform set is organized in a second data domain, and wherein an extent of the second data domain comprises an extent of the first data domain,
partition the first data domain in training bins to generate a plurality of training subsets from the training waveform set, wherein each training subset is associated to a corresponding training bin,
determine a plurality of initial first arrivals based on the plurality of training subsets, wherein each initial first arrival is associated to a corresponding training subset, and wherein each initial first arrival is based on picking a first arrival of at least one time-space waveform of the corresponding training subset,
form a training dataset, wherein the training dataset comprises an input training dataset and an output training dataset, wherein the input training dataset is based on the plurality of training subsets and the output training dataset is based on the plurality of initial first arrivals, and
train, using the training dataset, the trainable machine-learning (ML) network to predict the output training dataset, at least in part, from the input training dataset.

13. The system of claim 12, wherein the seismic processing system is further configured to train a plurality of ML subnetworks, wherein each ML subnetwork is trained to predict each initial first arrival from, at least in part, the corresponding training subset.

14. The system of claim 12, further comprising a seismic acquisition system configured to acquire the seismic dataset.

15. The system of claim 13, wherein the seismic processing system is further configured to:
form a plurality of input subsets from the plurality of time-space waveforms; and
determine a plurality of predicted first arrivals using the plurality of ML subnetworks,
wherein each predicted arrival is associated to a corresponding input subset, and
each ML subnetwork is used to predict a predicted first arrival from, at least in part, the corresponding input subset.

16. The system of claim 15, wherein the seismic processing system is further configured to form the plurality of input subsets using the training bins, wherein each waveform of the input subset is located in a corresponding training bin.

17. The system of claim 15, wherein the seismic processing system is further configured to generate a seismic image based, at least in part, on the plurality of predicted first arrivals.

18. The system of claim 17, further comprising:
a seismic interpretation system configured to determine a drilling target in the subsurface region based, at least in part, on the seismic image;
a wellbore planning system configured to plan a planned wellbore trajectory to intersect the drilling target; and
a drilling system configured to drill a portion of a wellbore guided by the planned wellbore trajectory.

19. The system of claim 12, wherein the seismic processing system is further configured to:
receive a second plurality of time-space waveforms organized in a third data domain, wherein the extent of the second data domain comprises an extent of the third data domain; and
predict, using the trained ML network, a plurality of predicted first arrivals based, at least in part, on the second plurality of time-space waveforms.

20. The system of claim 14, wherein the seismic dataset comprises a plurality of observed time-space waveforms, and wherein the seismic processing system is further configured to:
predict the plurality of first arrivals using the trained ML network based, at least in part, on the plurality of observed time-space waveforms;
receive a seismic velocity model of the subsurface region of interest; and
generate an updated seismic velocity model iteratively, or recursively, until a stopping condition is reached, wherein generating the updated seismic velocity model comprises:
generating a synthetic seismic dataset based, at least in part, on the seismic velocity model and a geometry of the plurality of observed time-space waveforms, and
updating the seismic velocity model based, at least in part, on the synthetic seismic dataset, the plurality of predicted first arrivals and the plurality of observed time-space waveforms.
